(19) United States
(12) Patent Application Publication
(10) Pub. No.: US 2024/0056661 A1
(43) Pub. Date: Feb. 15, 2024

(54) METHODS AND DEVICES FOR ACTIVE ATHERMALIZATION AND LENS POSITION INDEXING

(71) Applicant: GoPro, Inc., San Mateo, CA (US)

(72) Inventors: Ian Griggs, San Francisco, CA (US); Jonathan Stern, San Mateo, CA (US); Paul Finkel, Redwood City, CA (US)

(21) Appl. No.: 18/274,071

(22) PCT Filed: Jan. 25, 2022
(86) PCT No.: PCT/US2022/013739

§ 371 Date: Jul. 25, 2023

Related U.S. Application Data
(60) Provisional application No. 63/142,110, filed on Jan. 27, 2021.

(51) Int. Cl. H04N 23/52; H04N 17/00; H04N 23/68; H04N 23/55; H04N 23/54; G03B 13/36; G02B 7/02

(52) U.S. Cl. CPC H04N 23/52; H04N 17/002; H04N 23/687; H04N 23/55; H04N 23/54; G03B 13/36; G02B 7/028

(57) ABSTRACT

Devices for active athermalization and lens position indexing include an image capture device that includes a lens assembly, a lens mount, a memory, a printed circuit board (PCB), an image sensor, a temperature sensor, and actuator, and a processor. The memory stores a calibration look up table (LUT) that includes focus positions across a temperature range. The image sensor may be disposed on the PCB. The temperature sensor measures a temperature of the lens assembly. The processor determines a position of the lens assembly relative to the image sensor to maintain a focus point over the temperature range based on the calibration LUT, the measured temperature, or both. The processor may be configured to transmit a control signal to the actuator to modify the position of the lens assembly relative to the image sensor to maintain the focus point based on the measured temperature.

### TECHNICAL FIELD

This disclosure relates generally to methods and devices to control lens positioning for active athermalization or lens position indexing in action cameras.

### BACKGROUND

Imaging devices can include actuators, mechanisms that convert energy into operations such as linear movement, rotations, or bending, configured for use with lens assemblies in order to support calibration of focal length after assembly, to correct focal length due to thermal changes to components, or to allow for different modes of operation for the lens assembly. Though useful to correct positioning in these cases, imaging devices with actuators are susceptible to other motion, such as vibration, that can cause shakiness, wobbling, or other motion artifacts in an image or video capture which is exacerbated by the inherent ability to move enabled by the actuator.

### SUMMARY

Disclosed herein are implementations of methods and devices for active athermalization and lens position indexing. In an aspect, an image capture device may include a lens assembly, a lens mount, a memory, a printed circuit board (PCB), an image sensor, a temperature sensor, and actuator, and a processor. The lens assembly may include one or more lenses configured to refract light incident from an outer lens. The lens mount may be attached to the lens assembly. The memory may be configured to store a calibration look up table (LUT). The calibration LUT may include focus positions across a temperature range. The PCB may be positioned at an end of the lens mount. The image sensor may be disposed on the PCB. The image sensor may be configured to capture images based on the light incident on the image sensor refracted through the one or more lenses. The temperature sensor may be configured to measure a temperature of the lens assembly. The processor may be configured to determine a position of the lens assembly relative to the image sensor to maintain a focus point over the temperature range based on the calibration LUT, the measured temperature, or both. The processor may be configured to transmit a control signal to the actuator to modify the position of the lens assembly relative to the image sensor to maintain the focus point based on the measured temperature.

In an aspect, a free-floating micro-electro-mechanical system (MEMS) actuator may include a first portion, a second portion, a measurement circuit, a processor, and a variable direct current (DC) voltage source. The first portion and the second portion may be configured to form interdigital spaces. The interdigital spaces may form a variable capacitance. The first portion may be moveable, and the second portion may have a fixed position. The measurement circuit may be configured to monitor the variable capacitance and transmit variable capacitance data to the processor. The processor may be configured to determine a distance between the first portion and the second portion based on the variable capacitance data. The variable DC voltage source may be configured to variably adjust a voltage of the second portion based on the variable capacitance to maintain the distance between the first portion and the second portion.

In an aspect, an image capture device may include a lens assembly, a lens mount, a memory, a PCB, an image sensor, an actuator, and a processor. The lens assembly may include one or more lenses that are configured to refract light incident from an outer lens. The lens mount may be attached to the lens assembly. The memory may be configured to store stroke calibration data. The PCB may be positioned at an end of the lens mount. The image sensor may be disposed in a sensor housing on the PCB. The image sensor may be configured to capture images based on the light incident on the image sensor refracted through the one or more lenses. The actuator may be configured to perform back electromagnetic force (back-EMF) sensing. The processor may be configured to determine a position of the lens assembly relative to the image sensor to maintain a focus point based on the back-EMF sensing. The processor may be configured to create an index for the determined position. The processor may be configured to update the stroke calibration data based on the determined position.

In one or more aspects, the actuator may be a MEMS actuator. In one or more aspects, the MEMS actuator may be configured to modify the position of the image sensor. In one or more aspects, the actuator may be a stepper motor. In one or more aspects, the stepper motor may be configured to modify the position of the lens assembly. In one or more aspects, the stepper motor may be configured to modify the position of the PCB. In one or more aspects, the actuator may require an actuation voltage of at least 100V. In one or more aspects, the actuator may have an actuator displacement of less than 1 μm/g.

In one or more aspects, an image sensor may be attached to the first portion such that the free-floating MEMS actuator is configured to maintain a distance between the image sensor and a lens assembly for active athermalization. In one or more aspects, the free-floating MEMS actuator may be configured to maintain a distance between the image sensor and a lens assembly for vibration compensation. In one or more aspects, the measurement circuit is configured to monitor the variable capacitance in real-time. In one or more aspects, the measurement circuit is electrically coupled to the first portion and the second portion. In one or more aspects, the first portion is movable.

In one or more aspects, the processor may be configured to determine the position of the lens assembly on a condition that a portion of the lens assembly is in contact with the sensor housing. In one or more aspects, the processor may be configured to create the index when the image capture device is powered on. In one or more aspects, the processor may be configured to create the index on a condition that a shock, a change in temperature, or a change in humidity is detected.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-B are isometric views of an example of an image capture device.

FIGS. 2A-B are isometric views of another example of an image capture device.

FIG. 2C is a top view of the image capture device of FIGS. 2A-B.

FIG. 2D is a partial cross-sectional view of the image capture device of FIG. 2C.

FIG. 3 is a block diagram of electronic components of an image capture device.

FIG. 4 is a flow diagram of an example of a calibration method in accordance with embodiments of this disclosure.

FIG. 5 is a flow diagram of an example of an active athermalization method in accordance with embodiments of this disclosure.

FIG. 6 is a block diagram of a cross-sectional side view of an example of an image capture device configured with a micro-electro-mechanical system (MEMS) image sensor activator for active athermalization in accordance with embodiments of this disclosure.

FIG. 7 is a block diagram of an example of a free-floating MEMS actuator in accordance with embodiments of this disclosure.

FIG. 8 is a block diagram of a cross-sectional side view of an example of an image capture device configured with a stepper motor lens actuator for active athermalization in accordance with embodiments of this disclosure.

FIG. 9 is a block diagram of a cross-sectional side view of an example of an image capture device configured with a stepper motor printed circuit board (PCB) actuator for active athermalization in accordance with embodiments of this disclosure.

FIG. 10 is a block diagram of a cross-sectional side view of an example of an image capture device configured with a back electromagnetic force (back-EMF) sensor for lens position indexing in accordance with embodiments of this disclosure.

FIGS. 11A and 11B are block diagrams of cross-sectional side views of examples of an image capture device configured with a closed-loop lens position sensor in accordance with embodiments of this disclosure.

### DETAILED DESCRIPTION

Humidity, shock, and vibration may cause unpredictable focus shifts in image capture devices. Typical solutions to reduce optical alignment errors in focus include indexing the lens withing the lens actuator assembly, which cannot account for any shifts between that index point and the sensor housing.

In some embodiments described herein, an actuator can be used to modify a position of a lens barrel and/or barrel mount in relation to an image sensor or other components in an image capture device, for example to modify focus, or correct focus for thermal degradation. In some embodiments described herein, an actuator can be used to modify a position of the image sensor relative to the lens assembly to modify focus, or correct focus for thermal degradation.

In some embodiments, indexing the lens focus alignment directly between the mechanical surfaces of the lens barrel and the sensor housing may account for more alignment shifts and lead to better focus alignment over the life of the image capture device. This may be accomplished by designing a lens barrel and sensor housing geometry with reduced clearance, adding an intended contact point between the two parts, increasing the actuator stroke, using a motor controller with back-EMF sensing, or any combination thereof, and calibrating and tuning the motor controller to determine when contact is made with high precision and accuracy.

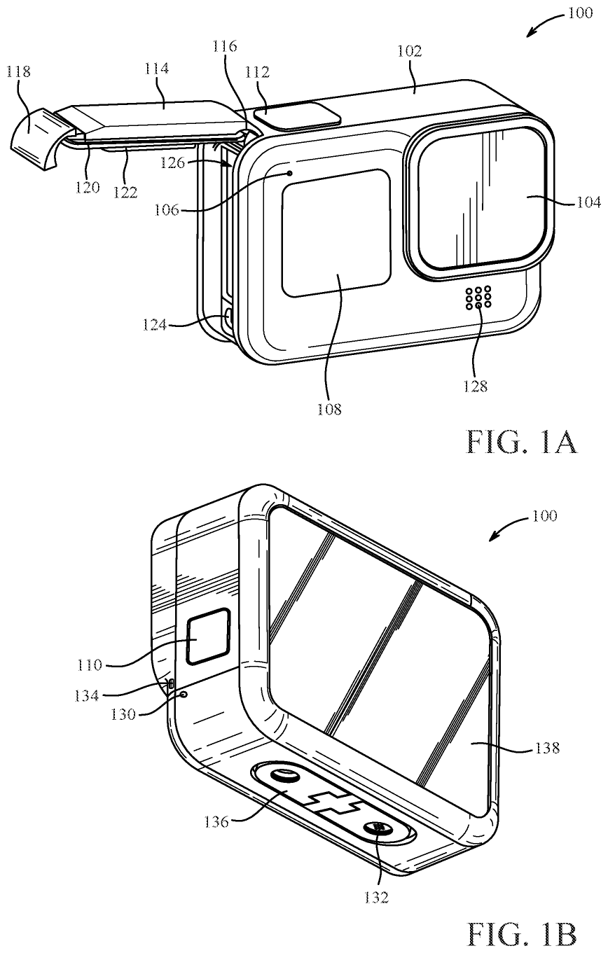

FIGS. 1A-B are isometric views of an example of an image capture device 100. The image capture device 100 may include a body 102, a lens 104 structured on a front surface of the body 102, various indicators on the front surface of the body 102 (such as light-emitting diodes (LEDs), displays, and the like), various input mechanisms (such as buttons, switches, and/or touch-screens), and electronics (such as imaging electronics, power electronics, etc.) internal to the body 102 for capturing images via the lens 104 and/or performing other functions. The lens 104 is configured to receive light incident upon the lens 104 and to direct received light onto an image sensor internal to the body 102. The image capture device 100 may be configured to capture images and video and to store captured images and video for subsequent display or playback.

The image capture device 100 may include an LED or another form of indicator 106 to indicate a status of the image capture device 100 and a liquid-crystal display (LCD) or other form of a display 108 to show status information such as battery life, camera mode, elapsed time, and the like. The image capture device 100 may also include a mode button 110 and a shutter button 112 that are configured to allow a user of the image capture device 100 to interact with the image capture device 100. For example, the mode button 110 and the shutter button 112 may be used to turn the image capture device 100 on and off, scroll through modes and settings, and select modes and change settings. The image capture device 100 may include additional buttons or interfaces (not shown) to support and/or control additional functionality.

The image capture device 100 may include a door 114 coupled to the body 102, for example, using a hinge mechanism 116. The door 114 may be secured to the body 102 using a latch mechanism 118 that releasably engages the body 102 at a position generally opposite the hinge mechanism 116. The door 114 may also include a seal 120 and a battery interface 122. When the door 114 is an open position, access is provided to an input-output (I/O) interface 124 for connecting to or communicating with external devices as described below and to a battery receptacle 126 for placement and replacement of a battery (not shown). The battery receptacle 126 includes operative connections (not shown) for power transfer between the battery and the image capture device 100. When the door 114 is in a closed position, the seal 120 engages a flange (not shown) or other interface to provide an environmental seal, and the battery interface 122 engages the battery to secure the battery in the battery receptacle 126. The door 114 can also have a removed position (not shown) where the entire door 114 is separated from the image capture device 100, that is, where both the hinge mechanism 116 and the latch mechanism 118 are decoupled from the body 102 to allow the door 114 to be removed from the image capture device 100.

The image capture device 100 may include a microphone 128 on a front surface and another microphone 130 on a side surface. The image capture device 100 may include other microphones on other surfaces (not shown). The microphones 128, 130 may be configured to receive and record audio signals in conjunction with recording video or separate from recording of video. The image capture device 100 may include a speaker 132 on a bottom surface of the image capture device 100. The image capture device 100 may include other speakers on other surfaces (not shown). The speaker 132 may be configured to play back recorded audio or emit sounds associated with notifications.

A front surface of the image capture device 100 may include a drainage channel 134. A bottom surface of the image capture device 100 may include an interconnect mechanism 136 for connecting the image capture device 100 to a handle grip or other securing device. In the example shown in FIG. 1B, the interconnect mechanism 136 includes folding protrusions configured to move between a nested or collapsed position as shown and an extended or open position (not shown) that facilitates coupling of the protrusions to mating protrusions of other devices such as handle grips, mounts, clips, or like devices.

The image capture device 100 may include an interactive display 138 that allows for interaction with the image capture device 100 while simultaneously displaying information on a surface of the image capture device 100.

The image capture device 100 of FIGS. 1A-B includes an exterior that encompasses and protects internal electronics. In the present example, the exterior includes six surfaces (i.e. a front face, a left face, a right face, a back face, a top face, and a bottom face) that form a rectangular cuboid. Furthermore, both the front and rear surfaces of the image capture device 100 are rectangular. In other embodiments, the exterior may have a different shape. The image capture device 100 may be made of a rigid material such as plastic, aluminum, steel, or fiberglass. The image capture device 100 may include features other than those described here. For example, the image capture device 100 may include additional buttons or different interface features, such as interchangeable lenses, cold shoes, and hot shoes that can add functional features to the image capture device 100.

The image capture device 100 may include various types of image sensors, such as charge-coupled device (CCD) sensors, active pixel sensors (APS), complementary metal-oxide-semiconductor (CMOS) sensors, N-type metal-oxide-semiconductor (NMOS) sensors, and/or any other image sensor or combination of image sensors.

Although not illustrated, in various embodiments, the image capture device 100 may include other additional electrical components (e.g., an image processor, camera system-on-chip (SoC), etc.), which may be included on one or more circuit boards within the body 102 of the image capture device 100.

The image capture device 100 may interface with or communicate with an external device, such as an external user interface device (not shown), via a wired or wireless computing communication link (e.g., the I/O interface 124). Any number of computing communication links may be used. The computing communication link may be a direct computing communication link or an indirect computing communication link, such as a link including another device or a network, such as the internet, may be used.

In some implementations, the computing communication link may be a Wi-Fi link, an infrared link, a Bluetooth (BT) link, a cellular link, a ZigBee link, a near field communications (NFC) link, such as an ISO/IEC 20643 protocol link, an Advanced Network Technology interoperability (ANT+) link, and/or any other wireless communications link or combination of links.

In some implementations, the computing communication link may be an HDMI link, a USB link, a digital video interface link, a display port interface link, such as a Video Electronics Standards Association (VESA) digital display interface link, an Ethernet link, a Thunderbolt link, and/or other wired computing communication link.

The image capture device 100 may transmit images, such as panoramic images, or portions thereof, to the external user interface device via the computing communication link, and the external user interface device may store, process, display, or a combination thereof the panoramic images.

The external user interface device may be a computing device, such as a smartphone, a tablet computer, a phablet, a smart watch, a portable computer, personal computing device, and/or another device or combination of devices configured to receive user input, communicate information with the image capture device 100 via the computing communication link, or receive user input and communicate information with the image capture device 100 via the computing communication link.

The external user interface device may display, or otherwise present, content, such as images or video, acquired by the image capture device 100. For example, a display of the external user interface device may be a viewport into the three-dimensional space represented by the panoramic images or video captured or created by the image capture device 100.

The external user interface device may communicate information, such as metadata, to the image capture device 100. For example, the external user interface device may send orientation information of the external user interface device with respect to a defined coordinate system to the image capture device 100, such that the image capture device 100 may determine an orientation of the external user interface device relative to the image capture device 100.

Based on the determined orientation, the image capture device 100 may identify a portion of the panoramic images or video captured by the image capture device 100 for the image capture device 100 to send to the external user interface device for presentation as the viewport. In some implementations, based on the determined orientation, the image capture device 100 may determine the location of the external user interface device and/or the dimensions for viewing of a portion of the panoramic images or video.

The external user interface device may implement or execute one or more applications to manage or control the image capture device 100. For example, the external user interface device may include an application for controlling camera configuration, video acquisition, video display, or any other configurable or controllable aspect of the image capture device 100.

The user interface device, such as via an application, may generate and share, such as via a cloud-based or social media service, one or more images, or short video clips, such as in response to user input. In some implementations, the external user interface device, such as via an application, may remotely control the image capture device 100 such as in response to user input.

The external user interface device, such as via an application, may display unprocessed or minimally processed images or video captured by the image capture device 100 contemporaneously with capturing the images or video by the image capture device 100, such as for shot framing or live preview, and which may be performed in response to user input. In some implementations, the external user interface device, such as via an application, may mark one or more key moments contemporaneously with capturing the images or video by the image capture device 100, such as with a tag or highlight in response to a user input or user gesture.

The external user interface device, such as via an application, may display or otherwise present marks or tags associated with images or video, such as in response to user input. For example, marks may be presented in a camera roll application for location review and/or playback of video highlights.

The external user interface device, such as via an application, may wirelessly control camera software, hardware, or both. For example, the external user interface device may include a web-based graphical interface accessible by a user for selecting a live or previously recorded video stream from the image capture device 100 for display on the external user interface device.

The external user interface device may receive information indicating a user setting, such as an image resolution setting (e.g., 3840 pixels by 2160 pixels), a frame rate setting (e.g., 60 frames per second (fps)), a location setting, and/or a context setting, which may indicate an activity, such as mountain biking, in response to user input, and may communicate the settings, or related information, to the image capture device 100.

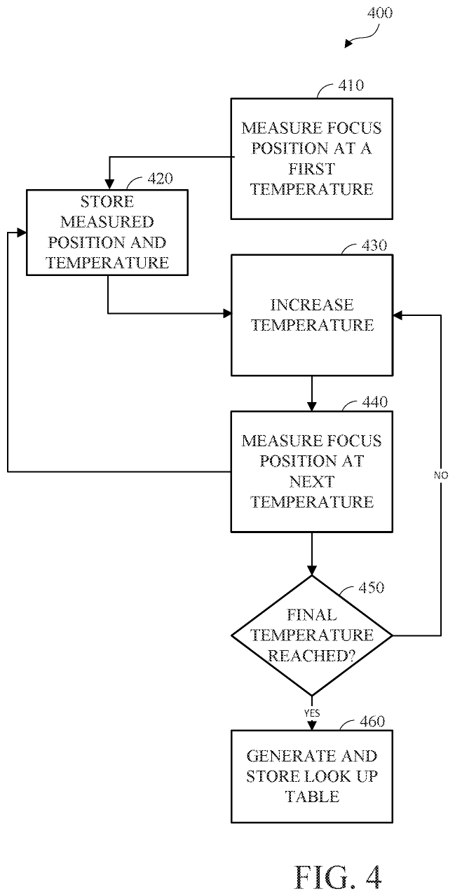

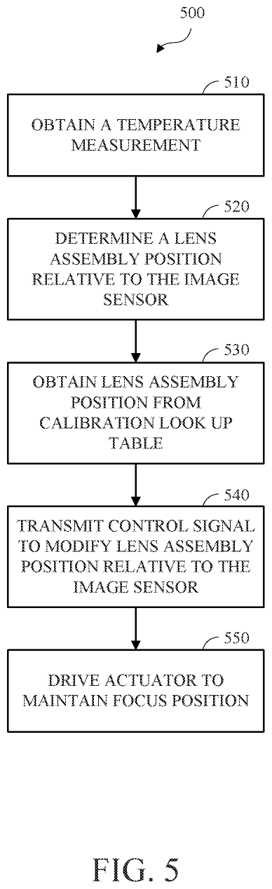

The image capture device 100 may be used to implement some or all of the techniques described in this disclosure, such as the calibration and athermalization techniques described in FIGS. 4 and 5.

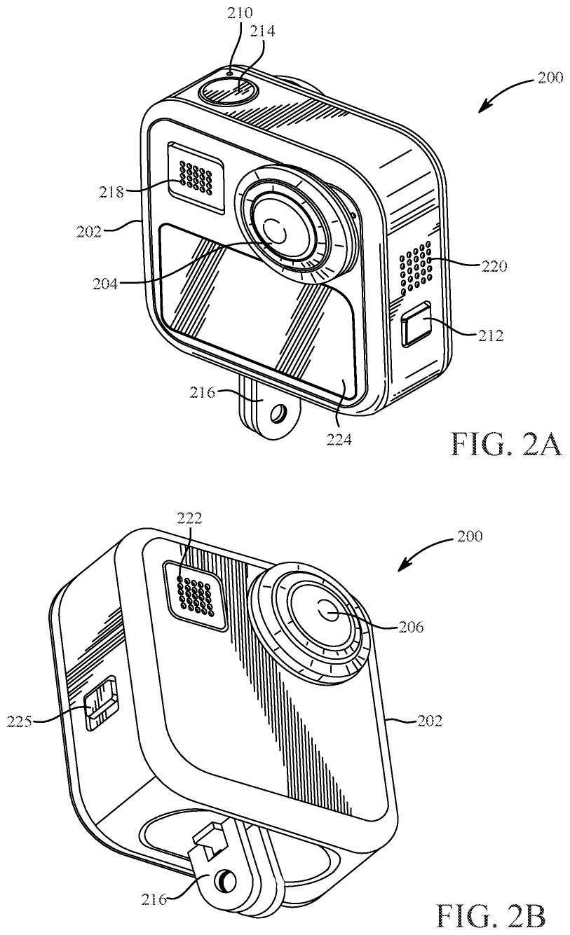

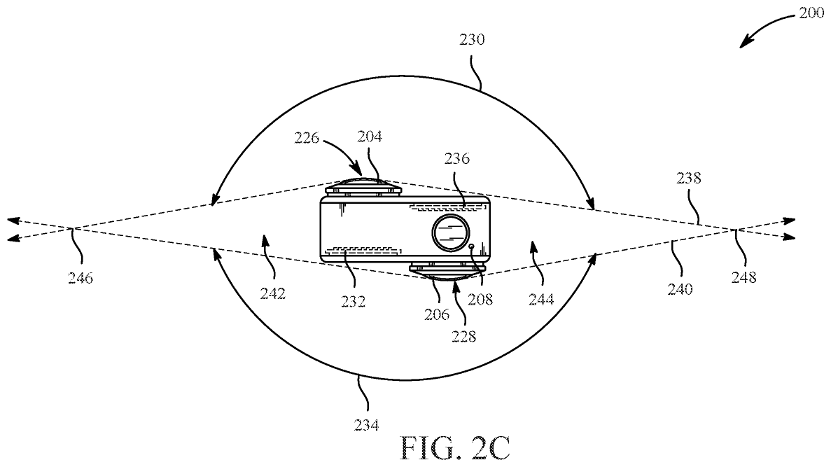

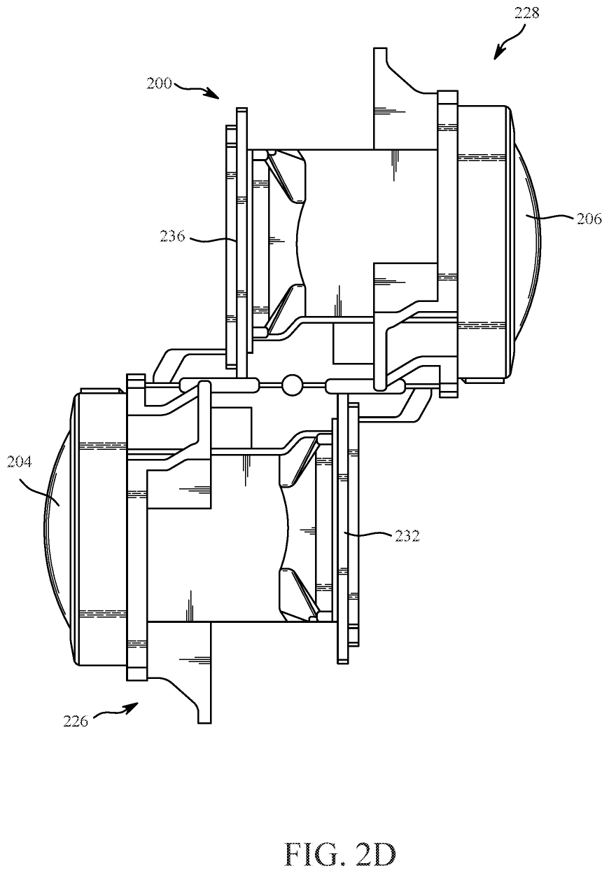

FIGS. 2A-B illustrate another example of an image capture device 200. The image capture device 200 includes a body 202 and two camera lenses 204 and 206 disposed on opposing surfaces of the body 202, for example, in a back-to-back configuration, Janus configuration, or offset Janus configuration. The body 202 of the image capture device 200 may be made of a rigid material such as plastic, aluminum, steel, or fiberglass.

The image capture device 200 includes various indicators on the front of the surface of the body 202 (such as LEDs, displays, and the like), various input mechanisms (such as buttons, switches, and touch-screen mechanisms), and electronics (e.g., imaging electronics, power electronics, etc.) internal to the body 202 that are configured to support image capture via the two camera lenses 204 and 206 and/or perform other imaging functions.

The image capture device 200 includes various indicators, for example, LEDs 208, 210 to indicate a status of the image capture device 100. The image capture device 200 may include a mode button 212 and a shutter button 214 configured to allow a user of the image capture device 200 to interact with the image capture device 200, to turn the image capture device 200 on, and to otherwise configure the operating mode of the image capture device 200. It should be appreciated, however, that, in alternate embodiments, the image capture device 200 may include additional buttons or inputs to support and/or control additional functionality.

The image capture device 200 may include an interconnect mechanism 216 for connecting the image capture device 200 to a handle grip or other securing device. In the example shown in FIGS. 2A and 2B, the interconnect mechanism 216 includes folding protrusions configured to move between a nested or collapsed position (not shown) and an extended or open position as shown that facilitates coupling of the protrusions to mating protrusions of other devices such as handle grips, mounts, clips, or like devices.

The image capture device 200 may include audio components 218, 220, 222 such as microphones configured to receive and record audio signals (e.g., voice or other audio commands) in conjunction with recording video. The audio component 218, 220, 222 can also be configured to play back audio signals or provide notifications or alerts, for example, using speakers. Placement of the audio components 218, 220, 222 may be on one or more of several surfaces of the image capture device 200. In the example of FIGS. 2A and 2B, the image capture device 200 includes three audio components 218, 220, 222, with the audio component 218 on a front surface, the audio component 220 on a side surface, and the audio component 222 on a back surface of the image capture device 200. Other numbers and configurations for the audio components are also possible.

The image capture device 200 may include an interactive display 224 that allows for interaction with the image capture device 200 while simultaneously displaying information on a surface of the image capture device 200. The interactive display 224 may include an I/O interface, receive touch inputs, display image information during video capture, and/or provide status information to a user. The status information provided by the interactive display 224 may include battery power level, memory card capacity, time elapsed for a recorded video, etc.

The image capture device 200 may include a release mechanism 225 that receives a user input to in order to change a position of a door (not shown) of the image capture device 200. The release mechanism 225 may be used to open the door (not shown) in order to access a battery, a battery receptacle, an I/O interface, a memory card interface, etc. (not shown) that are similar to components described in respect to the image capture device 100 of FIGS. 1A and 1B.

In some embodiments, the image capture device 200 described herein includes features other than those described. For example, instead of the I/O interface and the interactive display 224, the image capture device 200 may include additional interfaces or different interface features. For example, the image capture device 200 may include additional buttons or different interface features, such as interchangeable lenses, cold shoes, and hot shoes that can add functional features to the image capture device 200.

FIG. 2C is a top view of the image capture device 200 of FIGS. 2A-B and FIG. 2D is a partial cross-sectional view of the image capture device 200 of FIG. 2C. The image capture device 200 is configured to capture spherical images, and accordingly, includes a first image capture device 226 and a second image capture device 228. The first image capture device 226 defines a first field-of-view 230 and includes the lens 204 that receives and directs light onto a first image sensor 232. Similarly, the second image capture device 228 defines a second field-of-view 234 and includes the lens 206 that receives and directs light onto a second image sensor 236. To facilitate the capture of spherical images, the image capture devices 226 and 228 (and related components) may be arranged in a back-to-back (Janus) configuration such that the lenses 204, 206 face in generally opposite directions.

The fields-of-view 230, 234 of the lenses 204, 206 are shown above and below boundaries 238, 240 indicated in dotted line. Behind the first lens 204, the first image sensor 232 may capture a first hyper-hemispherical image plane from light entering the first lens 204, and behind the second lens 206, the second image sensor 236 may capture a second hyper-hemispherical image plane from light entering the second lens 206.

One or more areas, such as blind spots 242, 244 may be outside of the fields-of-view 230, 234 of the lenses 204, 206 so as to define a “dead zone.” In the dead zone, light may be obscured from the lenses 204, 206 and the corresponding image sensors 232, 236, and content in the blind spots 242, 244 may be omitted from capture. In some implementations, the image capture devices 226, 228 may be configured to minimize the blind spots 242, 244.

The fields-of-view 230, 234 may overlap. Stitch points 246, 248 proximal to the image capture device 200, that is, locations at which the fields-of-view 230, 234 overlap, may be referred to herein as overlap points or stitch points. Content captured by the respective lenses 204, 206 that is distal to the stitch points 246, 248 may overlap.

Images contemporaneously captured by the respective image sensors 232, 236 may be combined to form a combined image. Generating a combined image may include correlating the overlapping regions captured by the respective image sensors 232, 236, aligning the captured fields-of-view 230, 234, and stitching the images together to form a cohesive combined image.

A slight change in the alignment, such as position and/or tilt, of the lenses 204, 206, the image sensors 232, 236, or both, may change the relative positions of their respective fields-of-view 230, 234 and the locations of the stitch points 246, 248. A change in alignment may affect the size of the blind spots 242, 244, which may include changing the size of the blind spots 242, 244 unequally.

Incomplete or inaccurate information indicating the alignment of the image capture devices 226, 228, such as the locations of the stitch points 246, 248, may decrease the accuracy, efficiency, or both of generating a combined image. In some implementations, the image capture device 200 may maintain information indicating the location and orientation of the lenses 204, 206 and the image sensors 232, 236 such that the fields-of-view 230, 234, the stitch points 246, 248, or both may be accurately determined; the maintained information may improve the accuracy, efficiency, or both of generating a combined image.

The lenses 204, 206 may be laterally offset from each other, may be off-center from a central axis of the image capture device 200, or may be laterally offset and off-center from the central axis. As compared to image capture devices with back-to-back lenses, such as lenses aligned along the same axis, image capture devices including laterally offset lenses may include substantially reduced thickness relative to the lengths of the lens barrels securing the lenses. For example, the overall thickness of the image capture device 200 may be close to the length of a single lens barrel as opposed to twice the length of a single lens barrel as in a back-to-back lens configuration. Reducing the lateral distance between the lenses 204, 206 may improve the overlap in the fields-of-view 230, 234. In another embodiment (not shown), the lenses 204, 206 may be aligned along a common imaging axis.

Images or frames captured by the image capture devices 226, 228 may be combined, merged, or stitched together to produce a combined image, such as a spherical or panoramic image, which may be an equirectangular planar image. In some implementations, generating a combined image may include use of techniques including noise reduction, tone mapping, white balancing, or other image correction. In some implementations, pixels along the stitch boundary may be matched accurately to minimize boundary discontinuities.

The image capture device 200 may be used to implement some or all of the techniques described in this disclosure, such as the calibration and athermalization techniques described in FIGS. 4 and 5.

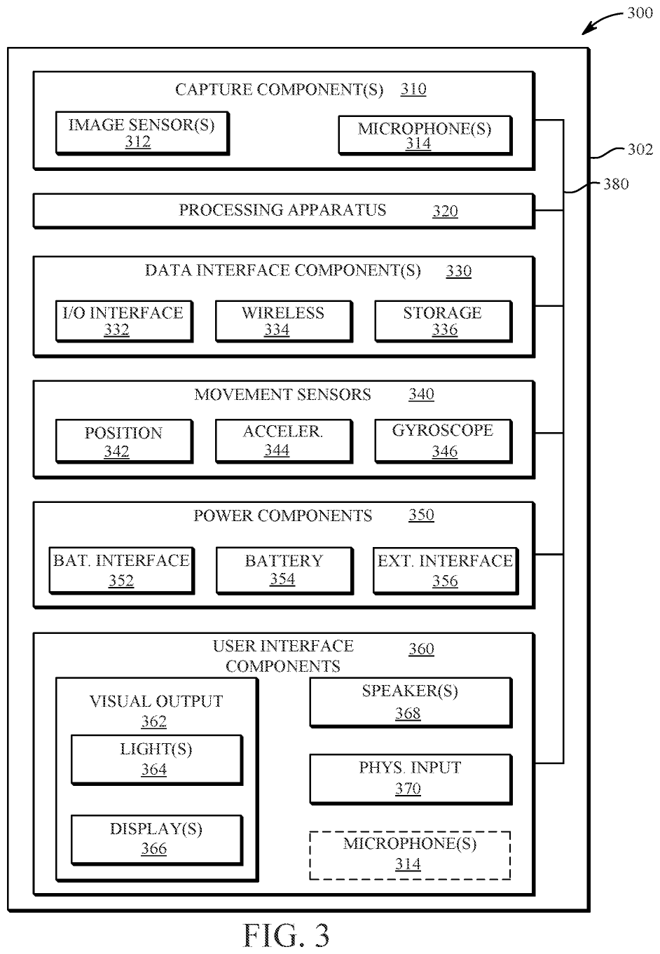

FIG. 3 is a block diagram of electronic components in an image capture device 300. The image capture device 300 may be a single-lens image capture device, a multi-lens image capture device, or variations thereof, including an image capture device with multiple capabilities such as use of interchangeable integrated sensor lens assemblies. The description of the image capture device 300 is also applicable to the image capture devices 100, 200 of FIGS. 1A-B and 2A-D.

The image capture device 300 includes a body 302 which includes electronic components such as capture components 310, a processing apparatus 320, data interface components 330, movement sensors 340, power components 350, and/or user interface components 360.

The capture components 310 include one or more image sensors 312 for capturing images and one or more microphones 314 for capturing audio.

The image sensor(s) 312 is configured to detect light of a certain spectrum (e.g., the visible spectrum or the infrared spectrum) and convey information constituting an image as electrical signals (e.g., analog or digital signals). The image sensor(s) 312 detects light incident through a lens coupled or connected to the body 302. The image sensor(s) 312 may be any suitable type of image sensor, such as a charge-coupled device (CCD) sensor, active pixel sensor (APS), complementary metal-oxide-semiconductor (CMOS) sensor, N-type metal-oxide-semiconductor (NMOS) sensor, and/or any other image sensor or combination of image sensors. Image signals from the image sensor(s) 312 may be passed to other electronic components of the image capture device 300 via a bus 380, such as to the processing apparatus 320. In some implementations, the image sensor(s) 312 includes a digital-to-analog converter. A multi-lens variation of the image capture device 300 can include multiple image sensors 312.

The microphone(s) 314 is configured to detect sound, which may be recorded in conjunction with capturing images to form a video. The microphone(s) 314 may also detect sound in order to receive audible commands to control the image capture device 300.

The processing apparatus 320 may be configured to perform image signal processing (e.g., filtering, tone mapping, stitching, and/or encoding) to generate output images based on image data from the image sensor(s) 312. The processing apparatus 320 may include one or more processors having single or multiple processing cores. In some implementations, the processing apparatus 320 may include an application specific integrated circuit (ASIC). For example, the processing apparatus 320 may include a custom image signal processor. The processing apparatus 320 may exchange data (e.g., image data) with other components of the image capture device 300, such as the image sensor(s) 312, via the bus 380.

The processing apparatus 320 may include memory, such as a random-access memory (RAM) device, flash memory, or another suitable type of storage device, such as a non-transitory computer-readable memory. The memory of the processing apparatus 320 may include executable instructions and data that can be accessed by one or more processors of the processing apparatus 320. For example, the processing apparatus 320 may include one or more dynamic random-access memory (DRAM) modules, such as double data rate synchronous dynamic random-access memory (DDR SDRAM). In some implementations, the processing apparatus 320 may include a digital signal processor (DSP). More than one processing apparatus may also be present or associated with the image capture device 300.

The data interface components 330 enable communication between the image capture device 300 and other electronic devices, such as a remote control, a smartphone, a tablet computer, a laptop computer, a desktop computer, or a storage device. For example, the data interface components 330 may be used to receive commands to operate the image capture device 300, transfer image data to other electronic devices, and/or transfer other signals or information to and from the image capture device 300. The data interface components 330 may be configured for wired and/or wireless communication. For example, the data interface components 330 may include an I/O interface 332 that provides wired communication for the image capture device, which may be a USB interface (e.g., USB type-C), a high-definition multimedia interface (HDMI), or a FireWire interface. The data interface components 330 may include a wireless data interface 334 that provides wireless communication for the image capture device 300, such as a Bluetooth interface, a ZigBee interface, and/or a Wi-Fi interface. The data interface components 330 may include a storage interface 336, such as a memory card slot configured to receive and operatively couple to a storage device (e.g., a memory card) for data transfer with the image capture device 300 (e.g., for storing captured images and/or recorded audio and video).

The movement sensors 340 may detect the position and movement of the image capture device 300. The movement sensors 340 may include a position sensor 342, an accelerometer 344, or a gyroscope 346. The position sensor 342, such as a global positioning system (GPS) sensor, is used to determine a position of the image capture device 300. The accelerometer 344, such as a three-axis accelerometer, measures linear motion (e.g., linear acceleration) of the image capture device 300. The gyroscope 346, such as a three-axis gyroscope, measures rotational motion (e.g., rate of rotation) of the image capture device 300. Other types of movement sensors 340 may also be present or associated with the image capture device 300.

The power components 350 may receive, store, and/or provide power for operating the image capture device 300. The power components 350 may include a battery interface 352 and a battery 354. The battery interface 352 operatively couples to the battery 354, for example, with conductive contacts to transfer power from the battery 354 to the other electronic components of the image capture device 300. The power components 350 may also include an external interface 356, and the power components 350 may, via the external interface 356, receive power from an external source, such as a wall plug or external battery, for operating the image capture device 300 and/or charging the battery 354 of the image capture device 300. In some implementations, the external interface 356 may be the I/O interface 332. In such an implementation, the I/O interface 332 may enable the power components 350 to receive power from an external source over a wired data interface component (e.g., a USB type-C cable).

The user interface components 360 may allow the user to interact with the image capture device 300, for example, providing outputs to the user and receiving inputs from the user. The user interface components 360 may include visual output components 362 to visually communicate information and/or present captured images to the user. The visual output components 362 may include one or more lights 364 and/or more displays 366. The display(s) 366 may be configured as a touch screen that receives inputs from the user. The user interface components 360 may also include one or more speakers 368. The speaker(s) 368 can function as an audio output component that audibly communicates information and/or presents recorded audio to the user. The user interface components 360 may also include one or more physical input interfaces 370 that are physically manipulated by the user to provide input to the image capture device 300. The physical input interfaces 370 may, for example, be configured as buttons, toggles, or switches. The user interface components 360 may also be considered to include the microphone(s) 314, as indicated in dotted line, and the microphone(s) 314 may function to receive audio inputs from the user, such as voice commands.

The image capture device 300 may be used to implement some or all of the techniques described in this disclosure, such as the calibration and athermalization techniques described in FIGS. 4 and 5.

FIG. 4 is a flow diagram of an example of a calibration method 400 in accordance with embodiments of this disclosure. The calibration method 400 may be used to create a look up table (LUT) to reduce focus error caused by thermal expansion by calibrating the thermal focus shift to the temperature sensor and actuating the lens assembly, image sensor, PCB, or any combination thereof, to compensate for the expected focus error. The calibration method 400 includes measuring a focus position across a temperature range. The calibration method 400 may be performed during manufacture assembly.

As shown in FIG. 4, the calibration method 400 includes measuring 410 a focused position at a first temperature. The first temperature may be any temperature, for example, the first temperature may be 0° C. The calibration method 400 includes storing 420 the measured focus position and temperature. The measured focus position and temperature may be stored in a memory, such as processing apparatus 320 shown in FIG. 3. The measured focus position and temperature may be stored in the memory as a table, for example a thermal LUT or a calibration data table.

The calibration method 400 includes increasing 430 the temperature and measuring 440 the focus position at a next temperature. The temperature is increased incrementally, and may be increased in any increment. In this example, the temperature may be increased to 1° C. (i.e., the next temperature in this example). The calibration method 400 includes, at the next temperature, storing 420 the measured focus position and temperature.

The calibration method 400 includes determining 450 whether the final temperature is reached. The final temperature may be any temperature and represents the end of the temperature calibration range. If the final temperature is not reached, the calibration method 400 continues to increase 430 the temperature to the next temperature, and the process repeats until the final temperature is reached. When the final temperature is reached, the calibration method 400 generates 460 the thermal LUT or calibration data table and stores it in the memory. The thermal LUT may also be referred to as the calibration LUT.

FIG. 5 is a flow diagram of an example of an active athermalization method 500 in accordance with embodiments of this disclosure. The active athermalization method 500 may be used to reduce focus error caused by thermal expansion by modifying the lens assembly position, PCB position, image sensor position, or any combination thereof, to compensate for the expected focus error.

The active athermalization method 500 includes obtaining 510 a temperature measurement. The temperature measurement may be obtained using a temperature sensor positioned internal to the image capture device housing or positioned external to the image capture device housing. The obtained temperature measurement may be of the lens assembly or of any internal or external component of the image capture device. The temperature measurement may be obtained continuously or periodically at predetermined intervals.

The active athermalization method 500 includes determining 520 a lens assembly position relative to the image sensor. The active athermalization method 500 includes obtaining 530 a lens assembly position from the calibration LUT generated in FIG. 4. The active athermalization method 500 includes transmitting 540 a control signal to an actuator. The control signal is configured to drive 550 the actuator to modify the lens assembly position relative to the image sensor to maintain the focus position. The actuator may be configured to modifying the lens assembly position, PCB position, image sensor position, or any combination thereof.

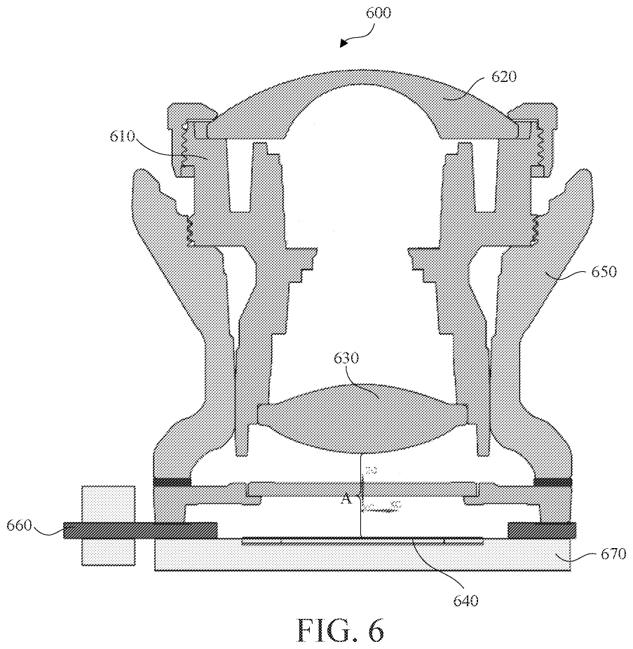

FIG. 6 is a block diagram of a cross-sectional side view of an example of an image capture device 600 configured with a micro-electro-mechanical system (MEMS) image sensor activator for active athermalization in accordance with embodiments of this disclosure. The image capture device 600 includes a lens barrel 610, an outer lens 620, an inner end lens 630, and an image sensor 640. The lens barrel 610 may be referred to as a lens assembly. The inner end lens 630 is positioned at a distal end of the lens barrel 610 closest to the image sensor 640. The image capture device 600 also includes a lens mount 650, a PCB 660, and an actuator 670 attached to the PCB 660. As shown in FIG. 6, the image sensor 640 is attached to a proximal end of the actuator 670 closest to the inner end lens 630.

In this example, the image capture device 600 includes the lens barrel 610 that is fixed in position with respect to the lens mount 650. The lens barrel 610 holds inner lenses, of which only the inner end lens 630 is shown, are configured to refract light propagating through the lens barrel 610 to focus the light for capture by the image sensor 640. The inner lenses may be oriented to direct light from a first end of the lens barrel 610 to a second end of the lens barrel 610 where the light may be detected by the image sensor 640 to capture an image or a video.

The image sensor 640 may be mounted within a body (not shown) of an image capture device proximate to an end of the lens barrel 610 near the inner end lens 630. The image sensor 640 may be configured to capture images based on light incident on the image sensor through the outer lens 620 and the inner lenses. The image sensor 640 may be configured to detect light of a certain spectrum (e.g., the visible spectrum or the infrared spectrum) and convey information constituting an image as electrical signals (e.g., analog or digital signals). For example, the image sensor 640 may include charge-coupled devices (CCD) or active pixel sensors in complementary metal-oxide-semiconductor (CMOS). In some implementations, the image sensor 640 may include a digital to analog converter. For example, the image sensor 640 may be configured to capture image data using a plurality of selectable exposure times.

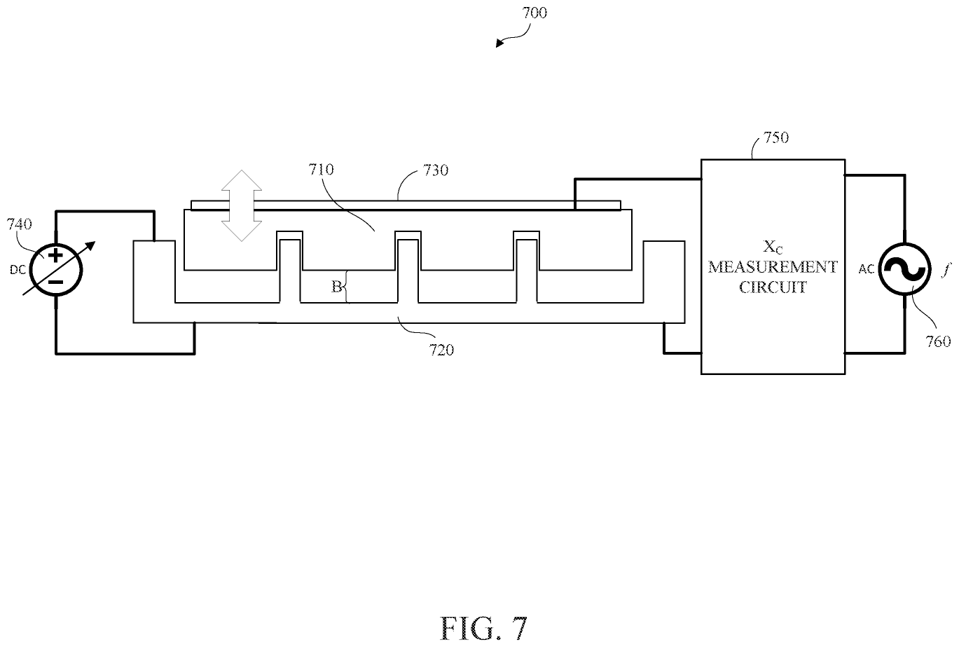

The actuator 670 may be configured to achieve active athermalization while having a low displacement and tolerant to input vibration. Accordingly, the actuator 670 may be configured such that it exhibits high stiffness to avoid vibration. The actuator 670 may require a high voltage, for example 100 V or higher, to produce a low displacement actuation. For example, the actuator 670 may be configured such that the displacement is 1 ∥m/g or lower, where g is gravity (i.e., 9.8 m/s²). In this example, the image capture device 600 may perform the active athermalization method 500 shown in FIG. 5 to modify a distance A based on the calibration LUT and a measured temperature to maintain focus position. The image capture device 600 may be configured to transmit a control signal to the actuator 670 to modify the voltage according to the calibration LUT to maintain the focus distance. In this example, the actuator 670 may be a free-floating MEMS actuator as described in further detail in FIG. 7. In this example, the actuator 670 is configured to actuate the image sensor 640 to modify the distance A while the lens barrel 610, lens mount 650, and PCB 660 remain in a fixed position.

FIG. 7 is a block diagram of an example of a free-floating MEMS actuator 700 in accordance with embodiments of this disclosure. The free-floating MEMS actuator 700 may be used to reduce position error caused by vibration by creating a closed-loop control system using capacitance. The free-floating MEMS actuator 700 may be used to stiffen and maintain an image plane at a focus position such that it may be controlled for athermalization purposes. In this example, instead of controlling the MEMS height by a voltage corresponding to a measured temperature, the height may be used such that the voltage may be allowed to vary based on the vibration to maintain the focus position. The free-floating MEMS actuator 700 may be implemented in an image capture device, such as image capture device 600 shown in FIG. 6, for example.

As shown in FIG. 7, the free-floating MEMS actuator 700 includes two arranged portions, top portion 710 and bottom portion 720. The top portion 710 and bottom portion 720 may be arranged in any fashion such that the distance between the two portions may be adjusted such that the resulting capacitance changes can be measured, for example, they may be interdigitally arranged as shown. The top portion 710 and the bottom portion 720 form interdigital spaces (shown as distance B) that form variable capacitance such that the capacitance increases as the interdigital space decreases. The bottom portion may be fixed to a PCB or any other component of the image capture device. An image sensor 730 of the image capture device may be attached to the top portion 710. The top portion 710 is movable and configured to increase or decrease distance B to adjust the position of the image sensor to maintain the focus position for active athermalization, vibration compensation, or both.

The free-floating MEMS actuator 700 includes a variable direct current (DC) voltage source 740 that is electrically coupled to the bottom portion 720, a measurement circuit 750 that is configured to sample an alternating current (AC) waveform 760. As shown in FIG. 7, the measurement circuit 750 is also electrically coupled to the top portion 710 and the bottom portion 720. The measurement circuit 750 is configured to sample the AC waveform 760 of the MEMS actuator 700 and is configured to monitor (i.e., sense) the variable capacitance (X_{c}) in real-time. The measurement circuit 750 may be configured to send the variable capacitance data to a processor or a microcontroller, such as processing apparatus 320 shown in FIG. 3, to determine the height (i.e., distance B) of the free-floating MEMS actuator 700. The height of the free-floating MEMS actuator may be determined according to Equations (1) and (2) below,

$$c = \frac{1}{2 π {fX}_{c}} \qquad Equation ( 1 )$$

$$d = \frac{{ε}_{0} A}{c} \qquad Equation ( 2 )$$

where C is the capacitance in Farads, ε₀ is the constant for the permittivity of free space (8.85×10⁻¹²), A is the effective area of the top portion 710 and bottom portion 720 in square meters, and d is the height (i.e., distance B).

The variable DC voltage source 740 is configured to variably adjust the voltage based on the variable capacitance measured by the measurement circuit 750 to maintain the height of the free-floating MEMS actuator, and in turn the image sensor 730, for active athermalization, vibration compensation, or both, without the need for a thermal LUT.

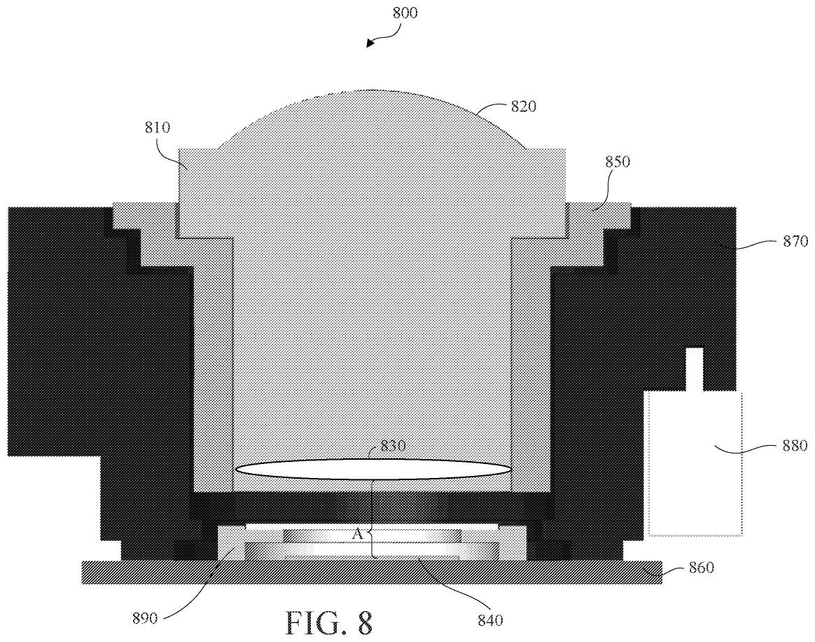

FIG. 8 is a block diagram of a cross-sectional side view of an example of an image capture device 800 configured with a stepper motor lens actuator for active athermalization in accordance with embodiments of this disclosure. The image capture device 800 includes a lens barrel 810, an outer lens 820, an inner end lens 830, and an image sensor 840. The lens barrel 810 may be referred to as a lens assembly. The inner end lens 830 is positioned at a distal end of the lens barrel 810 closest to the image sensor 840. The image capture device 800 also includes an actuator lens holder 850, a PCB 860, an actuator gearbox 870, and an actuator motor 880. The actuator lens holder 850, actuator gearbox 870, and actuator motor 880 may be collectively referred to as an actuator. The actuator motor 880 may be a stepper motor, a rotary motor, a linear motor, or a piezo-electric motor. In some embodiments, the actuator motor 880, the actuator gearbox 870, or both, may be implemented using a ball screw, a flexure, or any other mechanism sufficient to control a position of the lens barrel 810. As shown in FIG. 8, the image sensor 840 is attached to a proximal end of the PCB 860 closest to the inner end lens 830, and may be encased in a sensor housing 890.

In this example, the image capture device 800 includes the lens barrel 810 that is fixed in position with respect to the actuator lens holder 850. The lens barrel 810 holds inner lenses, of which only the inner end lens 830 is shown, are configured to refract light propagating through the lens barrel 810 to focus the light for capture by the image sensor 840. The inner lenses may be oriented to direct light from a first end of the lens barrel 810 to a second end of the lens barrel 810 where the light may be detected by the image sensor 840 to capture an image or a video.

The image sensor 840 may be mounted within the sensor housing 890 of an image capture device proximate to an end of the lens barrel 810 near the inner end lens 830. The image sensor 840 may be configured to capture images based on light incident on the image sensor through the outer lens 820 and the inner lenses. The image sensor 840 may be configured to detect light of a certain spectrum (e.g., the visible spectrum or the infrared spectrum) and convey information constituting an image as electrical signals (e.g., analog or digital signals). For example, the image sensor 840 may include CCD or active pixel sensors in CMOS. In some implementations, the image sensor 840 may include a digital to analog converter. For example, the image sensor 840 may be configured to capture image data using a plurality of selectable exposure times.

The actuator lens holder 850 may be actuated via the actuator motor 880 and the actuator gearbox 870 and configured to achieve active athermalization while having a low displacement and tolerant to input vibration. Accordingly, the actuator lens holder 850 may be configured such that it exhibits high stiffness to avoid vibration. The actuator motor 880 may require a voltage, for example 2.5 V to 5 V or higher, to produce a low displacement actuation. For example, the actuator lens holder 850 may be configured such that the displacement spring force is approximately 50 gram-force (gf) to 100 gf. In an example, the resistance of the lens position to vibration may be based on the spring force, and the lens mass may be approximately 2.5 g or less. In an example where a portion of the lens is actuated instead of the whole lens, the lens mass may be approximately 1 g. In this example, a spring exerting 100 gf on a 1 g lens-group may substantially maintain up to 100 g (gravity) before the force exceeds the 100 gf spring and causes lens displacement.

The image capture device 800 may perform the active athermalization method 500 shown in FIG. 5 to modify the distance A based on the calibration LUT and a measured temperature to maintain focus position. The image capture device 800 may be configured to transmit a control signal to the actuator motor 880 to modify the voltage according to the calibration LUT to maintain the focus distance. In this example, the actuator motor 880 is configured to actuate the actuator lens holder 850 and the lens barrel 610 to modify the distance A while the actuator gearbox 870 and PCB 860 remain in a fixed position.

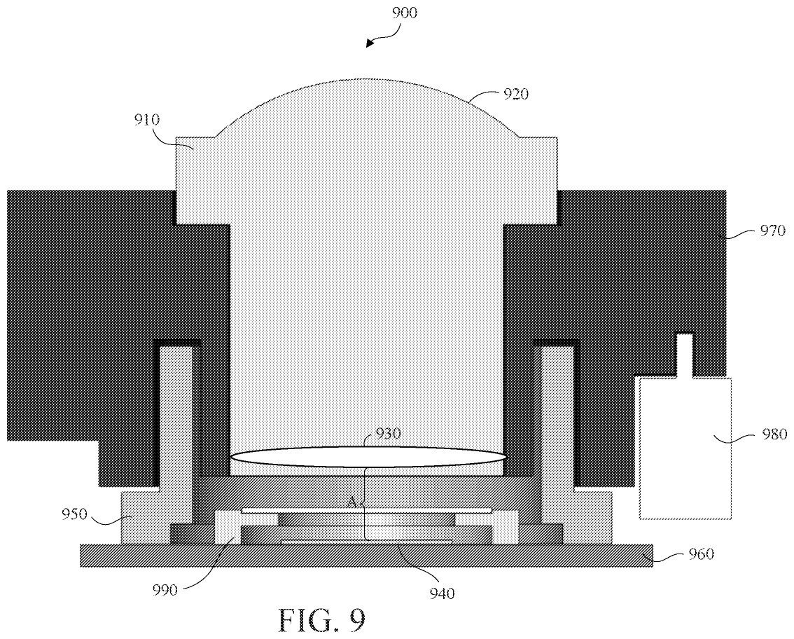

FIG. 9 is a block diagram of a cross-sectional side view of an example of an image capture device 900 configured with a stepper motor PCB actuator for active athermalization in accordance with embodiments of this disclosure. The image capture device 900 includes a lens barrel 910, an outer lens 920, an inner end lens 930, and an image sensor 940. The lens barrel 910 may be referred to as a lens assembly. The inner end lens 930 is positioned at a distal end of the lens barrel 910 closest to the image sensor 940. The image capture device 900 also includes an actuator PCB holder 850, a PCB 960, an actuator gearbox 970, and an actuator motor 980. The actuator PCB holder 950, actuator gearbox 970, and actuator motor 980 may be collectively referred to as an actuator. The actuator motor 980 may be a stepper motor, a rotary motor, a linear motor, or a piezo-electric motor. In some embodiments, the actuator motor 980, the actuator gearbox 970, or both, may be implemented using a ball screw, a flexure, or any other mechanism sufficient to control a position of the PCB 960. As shown in FIG. 9, the image sensor 940 is attached to a proximal end of the PCB 960 closest to the inner end lens 930, and may be encased in a sensor housing 990.

In this example, the image capture device 900 includes the lens barrel 910 that is fixed in position with respect to the actuator PCB holder 950. The lens barrel 910 holds inner lenses, of which only the inner end lens 930 is shown, are configured to refract light propagating through the lens barrel 910 to focus the light for capture by the image sensor 940. The inner lenses may be oriented to direct light from a first end of the lens barrel 910 to a second end of the lens barrel 910 where the light may be detected by the image sensor 940 to capture an image or a video.

The image sensor 940 may be mounted within the sensor housing 990 of an image capture device proximate to an end of the lens barrel 910 near the inner end lens 930. The image sensor 940 may be configured to capture images based on light incident on the image sensor through the outer lens 920 and the inner lenses. The image sensor 940 may be configured to detect light of a certain spectrum (e.g., the visible spectrum or the infrared spectrum) and convey information constituting an image as electrical signals (e.g., analog or digital signals). For example, the image sensor 940 may include CCD or active pixel sensors in CMOS. In some implementations, the image sensor 940 may include a digital to analog converter. For example, the image sensor 940 may be configured to capture image data using a plurality of selectable exposure times.

The actuator PCB holder 950 may be actuated via the actuator motor 980 and the actuator gearbox 970 and configured to achieve active athermalization while having a low displacement and tolerant to input vibration. Accordingly, the actuator PCB holder 950 may be configured such that it exhibits high stiffness to avoid vibration. The actuator motor 980 may require a voltage, for example 2.5 V to 5 V or higher, to produce a low displacement actuation. For example, the actuator PCB holder 950 may be configured such that the displacement spring force is approximately 50 gf to 100 gf. In an example, the resistance of the lens position to vibration may be based on the spring force, and the lens mass may be approximately 2.5 g or less. In an example where a portion of the lens is actuated instead of the whole lens, the lens mass may be approximately 1 g. In this example, a spring exerting 100 gf on a 1 g lens-group may substantially maintain up to 100 g (gravity) before the force exceeds the 100 gf spring and causes lens displacement.

The image capture device 900 may perform the active athermalization method 500 shown in FIG. 5 to modify the distance A based on the calibration LUT and a measured temperature to maintain focus position. The image capture device 900 may be configured to transmit a control signal to the actuator motor 980 to modify the voltage according to the calibration LUT to maintain the focus distance. In this example, the actuator motor 980 is configured to actuate the actuator PCB holder 950 and the image sensor 940 to modify the distance A while the actuator gearbox 970 and lens barrel 910 remain in a fixed position.

An actuator may lose calibration over the life of an image capture device due to thermal annealing, humidity absorption, shock, cycling, or any combination thereof. Accordingly, the lens may shift and lose alignment to the sensor housing over time. Typical actuators may have an internal indexing sensor to compensate for drivetrain issues, however these actuators do not account for the relative position of the lens to the image sensor. Accordingly, devices and systems are needed to index directly between the lens and the image sensor for a minimized risk of focus shift over the life of the image capture device.

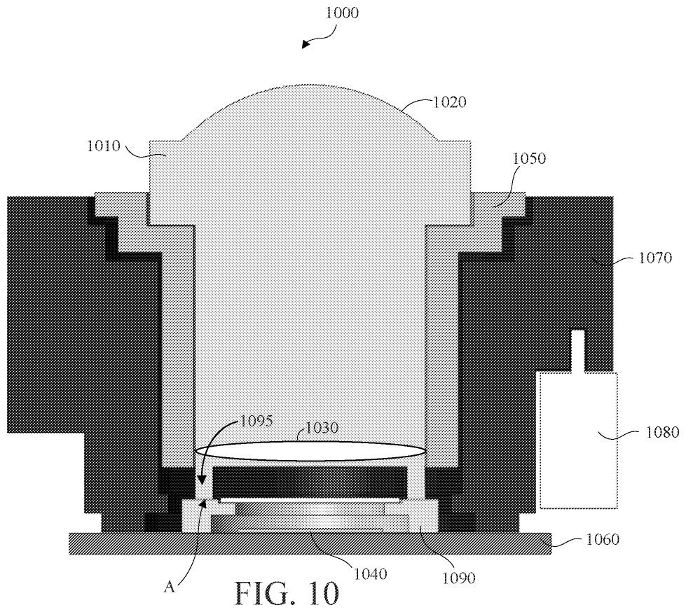

FIG. 10 is a block diagram of a cross-sectional side view of an example of an image capture device 1000 configured with a back electromagnetic force (back-EMF) sensor for lens position indexing in accordance with embodiments of this disclosure. The image capture device 1000 is configured to index directly between the lens and the image sensor for a minimized risk of focus shift over the life of the image capture device. The image capture device 1000 includes a lens barrel 1010, an outer lens 1020, an inner end lens 1030, and an image sensor 1040. The lens barrel 1010 may be referred to as a lens assembly. The inner end lens 1030 is positioned at a distal end of the lens barrel 1010 closest to the image sensor 1040. The image capture device 1000 also includes an actuator lens holder 1050, a PCB 1060, an actuator gearbox 1070, and an actuator motor 1080. The actuator lens holder 1050, actuator gearbox 1070, and actuator motor 1080 may be collectively referred to as an actuator. The actuator motor 1080 may be a stepper motor, a rotary motor, a linear motor, or a piezo-electric motor. In some embodiments, the actuator motor 1080, the actuator gearbox 1070, or both, may be implemented using a ball screw, a flexure, or any other mechanism sufficient to control a position of the lens barrel 1010. As shown in FIG. 10, the image sensor 1040 is attached to a proximal end of the PCB 1060 closest to the inner end lens 1030, and may be encased in a sensor housing 1090.

In this example, the image capture device 1000 includes the lens barrel 1010 that is fixed in position with respect to the actuator lens holder 1050. The lens barrel 1010 holds inner lenses, of which only the inner end lens 1030 is shown, are configured to refract light propagating through the lens barrel 1010 to focus the light for capture by the image sensor 1040. The inner lenses may be oriented to direct light from a first end of the lens barrel 1010 to a second end of the lens barrel 1010 where the light may be detected by the image sensor 1040 to capture an image or a video.

The image sensor 1040 may be mounted within the sensor housing 1090 of an image capture device proximate to an end of the lens barrel 1010 near the inner end lens 1030. The image sensor 1040 may be configured to capture images based on light incident on the image sensor through the outer lens 1020 and the inner lenses. The image sensor 1040 may be configured to detect light of a certain spectrum (e.g., the visible spectrum or the infrared spectrum) and convey information constituting an image as electrical signals (e.g., analog or digital signals). For example, the image sensor 1040 may include CCD or active pixel sensors in CMOS. In some implementations, the image sensor 1040 may include a digital to analog converter. For example, the image sensor 1040 may be configured to capture image data using a plurality of selectable exposure times.

In this example, the lens barrel 1010 may include a lower tab 1095 that is in physical contact with an upper surface A of the sensor housing 1090. The actuator may be configured with a driver (not shown). The driver may be configured to perform back-EMF sensing to create the index for the position where the lower tab 1095 is in contact with the upper surface A of the sensor housing 1090. At this position, a processor such as processing apparatus 320 shown in FIG. 3, may create a new reference point to determine the stroke and update the stroke calibration data with this new position to correct for any mechanical shifts since the last indexing event. Indexing the lens focus alignment directly between the mechanical surfaces of the lens barrel 1010 and the sensor housing 1090 in this manner may account for more alignment shifts and lead to improved focus alignment over the life of the image capture device 1000. In some embodiments, the lens barrel 1010 and the sensor housing 1090 geometry may have a reduced clearance, and adding an intended contact point between these two parts, increasing the actuator stroke, and using a motor controller with back-EMF sensing to calibrate and tune the motor controller to determine when contact is made with high precision and accuracy may lead to improved focus alignment over the life of the image capture device 1000. The image capture device 1000 may perform this indexing upon each time the image capture device 1000 is turned on or when a significant shock, change in temperature, or change in humidity is detected.

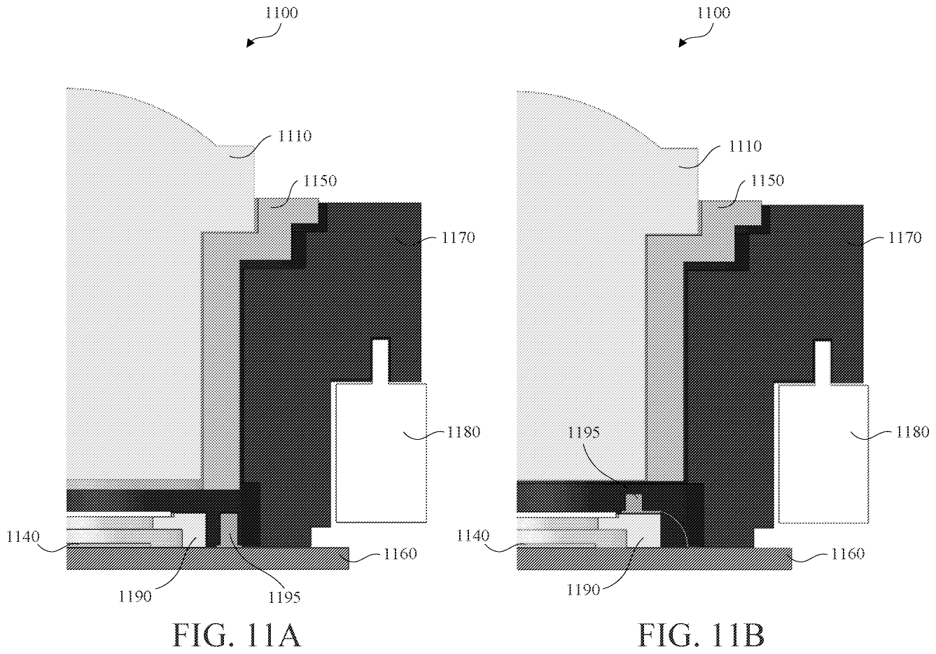

FIGS. 11A and 11B are block diagrams of cross-sectional side views of examples of an image capture device 1100 configured with a closed-loop lens position sensor in accordance with embodiments of this disclosure. The image capture device 1100 includes a lens barrel 1110 and an image sensor 1140. The lens barrel 1110 may be referred to as a lens assembly. The image capture device 1100 also includes an actuator lens holder 1150, a PCB 1160, an actuator gearbox 1170, and an actuator motor 1180. The actuator lens holder 1150, actuator gearbox 1170, and actuator motor 1180 may be collectively referred to as an actuator. The actuator motor 1180 may be a stepper motor, a rotary motor, a linear motor, or a piezo-electric motor. In some embodiments, the actuator motor 1180, the actuator gearbox 1170, or both, may be implemented using a ball screw, a flexure, or any other mechanism sufficient to control a position of the lens barrel 1110. As shown in FIG. 11, the image sensor 1140 is attached to a proximal end of the PCB 1160 closest to a distal end of the lens barrel 1110, and may be encased in a sensor housing 1190.

In this example, the image capture device 1100 includes the lens barrel 1110 that is fixed in position with respect to the actuator lens holder 1150. The lens barrel 1110 holds inner lenses (not shown) that are configured to refract light propagating through the lens barrel 1110 to focus the light for capture by the image sensor 1140. The inner lenses may be oriented to direct light from a first end of the lens barrel 1110 to a second end of the lens barrel 1110 where the light may be detected by the image sensor 1140 to capture an image or a video.

The image sensor 1140 may be mounted within the sensor housing 1190 of an image capture device proximate to an end of the lens barrel 1110. The image sensor 1140 may be configured to capture images based on light incident on the image sensor through the lens barrel 1110. The image sensor 1140 may be configured to detect light of a certain spectrum (e.g., the visible spectrum or the infrared spectrum) and convey information constituting an image as electrical signals (e.g., analog or digital signals). For example, the image sensor 1140 may include CCD or active pixel sensors in CMOS. In some implementations, the image sensor 1140 may include a digital to analog converter. For example, the image sensor 1140 may be configured to capture image data using a plurality of selectable exposure times.

In this example, a sensor 1195 may be used to directly measure the position of the lens barrel 1110. The sensor 1195 may be any suitable sensor, for example, a capacitance sensor or a Hall-effects sensor. The sensor 1195 may be positioned as closely as mechanically possible to the image sensor 1140 to minimize the risk of relative position changing over the life of the image capture device 1100. The sensor 1195 may be positioned on the PCB 1160 as shown in FIG. 11A, on the sensor housing 1190 as shown in FIG. 11B, or on the actuator (not shown) pointing down towards the PCB 1160. The sensor 1195 may be implemented in image capture device 800 shown in FIG. 8 or image capture device 900 shown in FIG. 9. Unlike the image capture device 1000 shown in FIG. 10 that is configured to use back-EMF sensing to indicate a single indexing position, image capture device 1100 is configured to update the stroke calibration data with multiple new lens positions across the entire stroke to correct for changes in the stroke.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

1. An image device comprising:
a lens assembly comprising lenses configured to refract light incident from an outer lens of the lenses;
a lens mount attached to the lens assembly;
a memory configured to store a calibration look up table (LUT), wherein the calibration LUT includes focus positions across a temperature range;
a printed circuit board (PCB) positioned at an end of the lens mount;
an image sensor disposed on the PCB and configured to capture images based on light incident on the image sensor refracted through the lenses;
a temperature sensor configured to measure a temperature of the lens assembly;
an actuator; and
a processor configured to:
determine a position of the lens assembly relative to the image sensor to maintain a focus point over the temperature range based on the calibration LUT and the measured temperature; and
transmit a control signal to the actuator to modify the position of the lens assembly relative to the image sensor to maintain the focus point based on the measured temperature.

2. The image capture device of claim 1, wherein the actuator is a micro-electro-mechanical system (MEMS) actuator.

3. The image capture device of claim 2, wherein the MEMS actuator is configured to modify the position of the image sensor.

4. The image capture device of claim 1, wherein the actuator is a stepper motor.

5. The image capture device of claim 4, wherein the stepper motor is configured to modify the position of the lens assembly.

6. The image capture device of claim 4, wherein the stepper motor is configured to modify the position of the PCB.

7. The image capture device of claim 1, wherein the actuator requires an actuation voltage of at least 100V.

8. The image capture device of claim 1, wherein the actuator has an actuator displacement of less than 1 μm/g.

9. A free-floating micro-electro-mechanical system (MEMS) actuator, comprising:
a first portion and a second portion configured to form interdigital spaces that form a variable capacitance, wherein the second portion is in a fixed position;
a measurement circuit configured to monitor the variable capacitance and transmit variable capacitance data;
a processor configured to determine a distance between the first portion and the second portion based on the variable capacitance data; and
a variable direct current (DC) voltage source configured to variably adjust a voltage of the second portion based on the variable capacitance to maintain the distance between the first portion and the second portion.

10. The free-floating MEMS actuator of claim 9, further comprising:
an image sensor attached to the first portion, wherein the free-floating MEMS actuator is configured to maintain a distance between the image sensor and a lens assembly for active athermalization.

11. The free-floating MEMS actuator of claim 10, further comprising:
an image sensor attached to the first portion, wherein the free-floating MEMS actuator is configured to maintain a distance between the image sensor and a lens assembly for vibration compensation.

12. The free-floating MEMS actuator of claim 10, wherein the measurement circuit is configured to monitor the variable capacitance in real-time.

13. The free-floating MEMS actuator of claim 10, wherein the measurement circuit is electrically coupled to the first portion and the second portion.

14. The free-floating MEMS actuator of claim 9, wherein the first portion is movable.

15. An image capture device, comprising:
a lens assembly comprising lenses configured to refract light incident from an outer lens of the lenses;
a lens mount attached to the lens assembly;
a memory configured to store stroke calibration data;
a printed circuit board (PCB) positioned at an end of the lens mount;
an image sensor disposed in a sensor housing on the PCB and configured to capture images based on light incident on the image sensor refracted through the lenses;
an actuator configured to perform back electromagnetic force (back-EMF) sensing; and
a processor configured to:
determine a position of the lens assembly relative to the image sensor to maintain a focus point based on the back-EMF sensing;
create an index for the determined position; and
update the stroke calibration data based on the determined position.

16. The image capture device of claim 15, wherein the processor is configured to determine the position of the lens assembly on a condition that a portion of the lens assembly is in contact with the sensor housing.

17. The image capture device of claim 16, wherein the processor is configured to create the index when the image capture device is powered on.

18. The image capture device of claim 16, wherein the processor is configured to create the index on a condition that a shock, a change in temperature, or a change in humidity is detected.

19. The image capture device of claim 15, wherein the actuator is a stepper motor.

20. The image capture device of claim 19, wherein the stepper motor is configured to modify the position of the lens assembly.
